(19) United States
(12) Patent Application Publication
(10) Pub. No.: US 2015/0139500 A1
(43) Pub. Date: May 21, 2015

(54) Method and System for Optimizing Image Processing in Driver Assistance Systems

(71) Applicants: Bayerische Motoren Werke Aktiengesellschaft, Muenchen (DE); Freescale Semiconductor Inc., Austin, TX (US)

(72) Inventors: Jochen GERSTER, Stuttgart (DE); Albrecht NEFF, Unterschleissheim (DE); Stefan SINGER, Vaterstetten (DE)

(21) Appl. No.: 14/608,357

(22) Filed: Jan. 29, 2015

Related U.S. Application Data
(63) Continuation of application No. PCT/EP2012/064885, filed on Jul. 30, 2012.

(51) Int. Cl. G06K 9/00; H04N 19/90; H04N 19/44; H04N 19/46; G06T 9/00; H04N 5/14

(52) U.S. Cl. CPC G06K 9/00805; G06T 9/00; H04N 5/14; H04N 19/44; H04N 19/46; H04N 19/90
USPC 382/104

(57) ABSTRACT

An imager simulator configured to be used in lieu of an imager within a vehicle is provided. The imager simulator includes an image source configured to store pre-determined reference data; and an imager interface unit configured to generate image data based on the pre-determined reference data. The image data conforms to a pre-determined format; and wherein the pre-determined format corresponds to a format of image data generated by the imager.

### CROSS REFERENCE TO RELATED APPLICATION

This application is a continuation of PCT International Application No. PCT/EP2012/064885, filed Jul. 30, 2012, the entire disclosure of which is herein expressly incorporated by reference.

### TECHNICAL FIELD

The present document relates to image processing. In particular, the present document relates to the optimization of image processing in a driver assistance system of a vehicle.

### BACKGROUND

Camera-based image/video applications (e.g. automotive driver assistance camera functions) often use image/video compression schemes in order to reduce the bandwidth required for the transmission of the image/video data from the camera through a network of the vehicle to an image/video analysis unit. Vehicles (such as cars or trucks) may comprise shared networks such as Ethernet networks, with limited bandwidth for the transmission of image/video data. Lossy image compression schemes (e.g. Joint Picture Group (JPEG), Motion JPEG (MJPEG), Moving Picture Experts Group (MPEG), H.264, etc.) may be used to reduce the data-rate for the transmission of image/video data (e.g. by a factor of 20 to 50). On the other hand, lossy image compression schemes typically lead to the creation of artifacts, the extent of which increases with an increasing compression ratio (i.e. with a reducing data-rate).

The image/video analysis unit may be configured to apply image/video analysis algorithms to the (compressed) image/video data (e.g. for the detection of a pedestrian). The artifacts comprised within the (compressed) image/video data may impact the performance of the image/video analysis algorithms. By way of example, the detection rate for pedestrian detection may be negatively affected, when increasing the compression ratio of the image/video compression scheme. As such, the parameter settings of the image/video compression schemes may affect the performance of the image/video analysis algorithms which are applied to the (compressed) image/video data.

The present document addresses the above mentioned problem of a driver assistance system which makes use of image/video analysis algorithms in conjunction with lossy image/video compression schemes. In particular, the present document describes methods and systems which are directed at improving the performance of image/video analysis algorithms when used in conjunction with lossy image/video compression schemes.

It should be noted that for conciseness, reference is made in the following to the term “image” only, wherein the term “image” is understood to comprise still images, as well as video (i.e. moving images).

### SUMMARY

According to an aspect, an imager simulator configured to be used in lieu of an imager within a vehicle is described. In particular, the imager simulator may be used in lieu of an imager within a driver assistance system of the vehicle. Alternatively or in addition, the imager simulator may be used in lieu of an imager within an infotainment system (e.g. a video communication system) of the vehicle. The driver assistance system may be a camera-based (also referred to as imager-based) driver assistance system. This means that the driver assistance system may comprise an imager (also referred to as an image sensor) configured to record an optical signal and to thereupon generate (digital) image data according to a particular data format. The imager simulator may be used within the driver assistance system in lieu of (i.e. in place of or instead of) the imager, in order to replace the image data, which is generated by the imager based on optical signals which are recorded by the image, by image data, which is generated based on pre-determined (and possibly pre-stored) reference data.

The imager simulator may comprise an image source configured to store the pre-determined reference data. The pre-determined reference data may comprise one or more of the following: image data recorded using the imager of the driver assistance system (in other words, image data which has been pre-recorded using the imager which is to be simulated by the imager simulator); image data generated by a pattern generator (representing e.g. artificially created objects to be detected by an image analysis unit of the driver assistance system); and image data representing a freeze image.

The imager simulator may further comprise an imager interface unit configured to generate image data based on the pre-determined reference data. The image data generated by the imager simulator is adapted to be used within the driver assistance system (instead of image data generated by the imager of the driver assistance system). The image data may conform to a pre-determined format, wherein the pre-determined format corresponds to the particular format of image data generated by the imager of the driver assistance system. The pre-determined format may be in conformity with a pre-determined standard, e.g. with the ITU-R BT.601 or the ITU-R BT.709 standard. Alternatively or in addition, the pre-determined format may specify one or more of the following: a resolution of a frame of the image data (e.g. a number of pixels per line and/or a number of pixels per column); a frame-rate of succeeding frames of the image data (e.g. a number of frames per second); a color space used to represent color information comprised within the image data (e.g. a luma component indicative of a brightness of a pixels, in conjunction with chrominance components indicative of relative color information of the pixel); a chroma subsampling scheme (e.g. indicative of a reduced spatial resolution for one or more components of a pixel); a number of bits used to encode a pixel of the image data (e.g. a number of bits used to encode each component of a pixel); a rate at which the bits which encode a pixel of the image data are transmitted (also referred to as a pixel clock); the use of synchronization signals, e.g. of Hsync, Href and/or Vsync signals, which may be used to indicate an end of a line and/or an end of a frame; an interlaced or de-interlaced operation of the imager; timing information for synchronization of the imager simulator with one or more components of the driver assistance system downstream of the imager (e.g. with a compression unit of the driver assistance system); and a serial or parallel transmission of the image data.

The imager simulator may comprise a physical connector (e.g. a coax connector) which conforms to the physical connector of the imager, such that the imager simulator may be integrated within the driver assistance system using the physical connector destined for the imager. In an embodiment, the imager simulator comprises a physical connector which corresponds to the physical connector of the imager and generates image data in the pre-determined format which corresponds to the particular format of the image data generated by the imager. As such, the imager simulator may be configured to completely take the place of the imager within the driver assistance system without the need of making any modifications to the rest of the driver assistance system. Furthermore, the imager simulator may be used to test the complete driver assistance system downstream of the output of the imager (wherein downstream refers to the flow direction of the image data through the driver assistance system).

According to another aspect, an evaluation system for determining a performance indicator of an imager-based driver assistance system is described. The evaluation system may comprise an imager simulator according to any of the aspects described in the present document. The imager simulator may be used in lieu of (e.g. by replacing) the imager of the driver assistance system. It should be noted that the imager simulator may be configured to simulate and replace a plurality of imagers of the driver assistance system (e.g. in case of stereo vision). As outlined above, the imager simulator may be configured to generate image data based on pre-determined reference data.

The evaluation system may further comprise an image analysis unit configured to analyze data derived from the image data, thereby generating analyzed image data. The image analysis unit may make use of one or more of a plurality of image analysis algorithms to generate the analyzed image data. An image analysis algorithm may e.g. be configured to perform line detection and/or obstacle detection. The analyzed image data may be indicative of zero or more objects detected within the data derived from the image data. The data derived from the image data may e.g. be the image data (in cases where the imager output is directly coupled to the image analysis unit, e.g. via dedicated bus). Alternatively, the data derived from the image data may e.g. be a compressed and subsequently decompressed version of the image data (in cases where the image data at the imager output is compressed for the purpose of bandwidth reduction).

The evaluation system may further comprise an evaluation unit configured to determine the performance indicator of the imager-based driver assistance system (or a performance indicator of the one or more image analysis algorithms used within the image analysis unit) based on the analyzed image data (in particular based on the zero or more objects detected within the data derived from the image data). The evaluation unit may be configured to determine the performance indicator also based on benchmark data derived from the pre-determined reference data. The benchmark data may e.g. be determined manually from the pre-determined reference data. The benchmark data may be indicative of one or more benchmark objects. Furthermore, the analyzed image data may be indicative of zero or more detected objects. In such cases, the performance indicator may comprise a detection rate of the one or more benchmark objects within the analyzed image data (e.g. by comparing the one or more benchmark objects with the zero or more detected objects).

The evaluation system (and the driver assistance system to be evaluated) may further comprise a compression unit configured to encode the image data using a lossy compressing scheme, thereby yielding compressed image data. The compression scheme which is applied within the compression unit may be adjusted using one or more settings, or, one or more sets of settings. In addition, the evaluation system (and the driver assistance system to be evaluated) may comprise a corresponding decompression unit configured to decode the compressed image data, thereby yielding decoded image data. The compression unit may be located at the imager/at the imager simulator and the decompression unit may be located at the image analysis unit. The compression unit and the decompression unit may be coupled via an on-board network (e.g. an Ethernet network) of the vehicle. As such, the compression unit and the decompression unit may be used to reduce the bandwidth of the image data sent from the imager simulator to the image analysis unit. As already indicated above, the image analysis unit may then be configured to analyze the decoded image data to provide the analyzed image data (i.e. the data derived from the image data may correspond to the decoded image data).

The compression unit may comprise one or more settings (or one or more sets of settings) which may be used to adjust the compression scheme which is applied to the image data. The one or more settings may relate to one or more of the following: the compression scheme, e.g. an MJPEG, a JPEG, an MPEG, or an H.264 algorithm, used within the compression unit; an overall or average target bit-rate or an overall or average compression ratio to be achieved by the compression scheme; a maximum bit-rate per frame of the image data or a maximum bit-rate per subregion of a frame of the image data; a quality criteria applied by the compression scheme when encoding the image data; a target average bit-rate per pre-determined time interval (e.g. per second); a maximum bit-rate per pre-determined time interval (e.g. per second); and a minimum value for a quality of the compressed image data with respect to the image data (the quality of the compressed image data may be indicated with respect to the quality criteria applied by the compression scheme).

The evaluation system may further comprise a reference image analysis unit configured to analyze the image data directly (without prior compression and decompression), thereby generating reference analyzed image data. Furthermore, the evaluation system may comprise a comparison unit configured to determine a performance deterioration of the imager-based driver assistance system (and/or of the image analysis unit) due to the lossy compressing scheme applied to the image data, based on the reference analyzed image data and based on the analyzed image data. Furthermore, the comparison unit (or an additional parameter tuning unit) may be configured to determine the one or more settings of the compression scheme used within the compression unit, which reduce (e.g. minimize) the performance deterioration of the imager-based driver assistance system (and/or of the image analysis unit).

According to another aspect, a method for determining a performance indicator of an imager-based driver assistance system (or of an image analysis unit comprised within the driver assistance system) is described. The method may comprise generating image data based on pre-determined reference data e.g. using an imager simulator in lieu of an imager of the driver assistance system. The imager simulator may be configured as described in the present document. The method may proceed in transmitting the image data over an on-board network of the vehicle within which the driver assistance system is used. Furthermore, the method may comprise analyzing data derived from the image data using a first image analysis algorithm, thereby generating analyzed image data. The first image analysis algorithm may be selected from a plurality of different image analysis algorithms. The performance indicator may be determined based on the analyzed image data.

The method may further comprise encoding the image data using a lossy compressing scheme. The compression scheme may be adjusted using a set of settings for the compression scheme. The set of settings may comprise e.g. one or more settings of compression schemes described in the present document. By applying the compression scheme (customized using a particular set of settings) to the image data, compressed image data is provided. The compressed image data may be decoded, thereby yielding decoded image data. In cases where the method comprises encoding and decoding, the analyzed image data may be determined based on the decoded image data.

The method may comprise repeating the generating step, the encoding step, the decoding step, the analyzing step and the determining step using the same pre-determined reference data but using different ones of a plurality of different sets of settings for the compression scheme, thereby yielding a corresponding plurality of performance indicators. In other words, the above mentioned method may be iterated using different sets of settings for the compression scheme. As such, a plurality of performance indicators of the driver assistance system (or of the image analysis unit) may be determined for different sets of settings for the compression scheme. The method may then comprise selecting a set of settings from the plurality of different sets of settings based on the plurality of performance indicators. By way of example, the set of settings may be selected which results in the highest performance indicator (e.g. in the highest detection rate).

It should be noted that the method may also be iterated for different image analysis algorithms used within the image analysis unit. As such, different sets of settings for the compression scheme may be selected, in dependence of the image analysis algorithm used within the image analysis unit. In particular, the method may comprise determining the plurality of performance indicators using a second image analysis algorithm, different from the first image analysis algorithm, thereby yielding a possibly different set of settings to be used in conjunction with the second image analysis algorithm.

According to a further aspect, an imager-based driver assistance system for a vehicle is described. The driver assistance system may comprise an imager configured to generate image data. The imager may comprise an optical camera configured to capture optical signals, thereby generating the (digital) image data. Furthermore, the driver assistance system may comprise a compression unit configured to encode the image data using a lossy compressing scheme, thereby yielding compressed image data. As described above, the compression scheme may be adjustable using one or more settings. The compressed image data may be transmitted over an on-board network (e.g. an Ethernet network) of the vehicle. The driver assistance system may further comprise a decompression unit configured to decode the compressed image data, thereby yielding decoded image data. In addition, the driver assistance system may comprise an image analysis unit configured to analyze the decoded image data using at least one of a plurality of image analysis algorithms, thereby yielding analyzed image data. The analyzed image data may be usable for assisting a driver of the vehicle. In particular, the driver assistance system may be configured to generate feedback information (e.g. a warning message) to the driver of the vehicle in dependence of the analyzed image data (e.g. when the analyzed image data comprises an object corresponding to a pedestrian).

The driver assistance system may comprise a memory unit configured to store one or more settings of the compression scheme for the plurality of image analysis algorithms, respectively. By way of example, the memory unit may be configured to store for each of the plurality of image analysis algorithms a corresponding set of one or more settings (e.g. in the form of a table). The driver assistance system may be configured to select and use the one or more settings for the compression scheme, stored in the memory unit, in dependence of the at least one image analysis algorithm used by the image analysis unit. As such, for different image analysis algorithms, different settings may be used for the compression scheme, thereby improving the overall performance of the driver assistance system.

According to a further aspect, a software program is described. The software program may be adapted for execution on a processor and for performing the method steps outlined in the present document when carried out on the processor.

According to another aspect, a storage medium is described. The storage medium may comprise a software program adapted for execution on a processor and for performing the method steps outlined in the present document when carried out on the processor.

According to a further aspect, a computer program product is described. The computer program may comprise executable instructions for performing the method steps outlined in the present document when executed on a computer.

It should be noted that the methods and systems including its preferred embodiments as outlined in the present patent application may be used stand-alone or in combination with the other methods and systems disclosed in this document. Furthermore, all aspects of the methods and systems outlined in the present patent application may be arbitrarily combined. In particular, the features of the claims may be combined with one another in an arbitrary manner.

Other objects, advantages and novel features of the present invention will become apparent from the following detailed description of one or more preferred embodiments when considered in conjunction with the accompanying drawings.

### BRIEF DESCRIPTION OF THE DRAWINGS

FIGS. 1a and 1b schematically illustrate exemplary systems for evaluating the performance of a driver assistance system;

FIGS. 2a and 2b schematically illustrate exemplary systems for evaluating the performance of a driver assistance system using hardware-in-the-loop techniques;

FIG. 3 is a block diagram illustration of an exemplary imager simulator;

FIG. 4 is a flow chart of an exemplary method for evaluating the performance of a driver assistance system; and

FIG. 5 is a schematic diagram illustrating another exemplary system for evaluating the performance of a driver assistance system.

### DETAILED DESCRIPTION OF THE DRAWINGS

Vehicles may include a driver assistance system which includes one or more image sensors (also referred to as imagers) configured to capture image data (e.g. a still image or a video). The captured image data may be transferred to an image analysis unit which analyzes the image data using one or more image analysis algorithms. Examples for image analysis algorithms are
a lane detection algorithm configured to detect whether the vehicle stays within a current lane of the road that the vehicle is driving on; and/or
an obstacle detection algorithm configured to detect whether an obstacle (e.g. a pedestrian or an animal) appears on the trajectory of the vehicle.

The image analysis algorithms are typically directed at the detection of one or more objects within the image data provided by one or more imagers. The image analysis algorithms typically make use of computer vision techniques, in particular object recognition techniques, such as CAD-like object-based methods, appearance-based methods and/or feature-based methods.

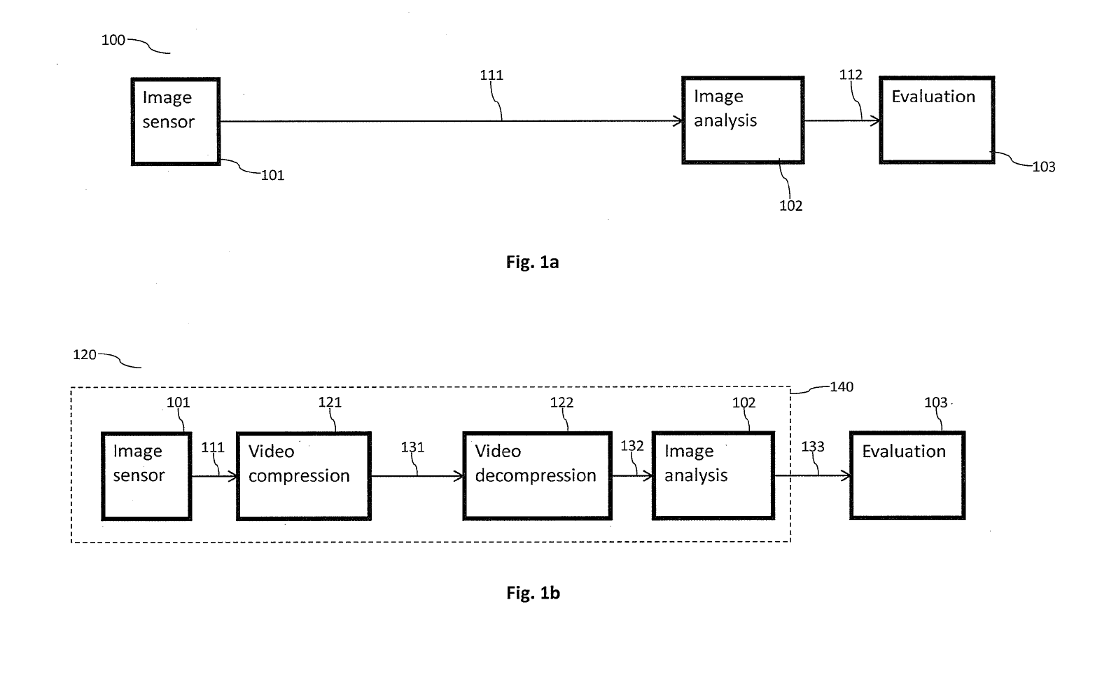

FIGS. 1a and 1b illustrate systems 100, 120 for evaluating the performance of such camera-based driver assistance systems. The system 100 includes an image sensor (also referred to as an imager) 101. The imager 101 generates image data 111 which is transmitted to an image analysis unit 102. The image data 111 may be in a pre-determined format, e.g. in a format which is in accordance to the ITU-R BT.601 specification (for video signals with 525-line or 625-line television systems) or in accordance to the ITU-R BT.709 specification (for high definition video signals of e.g. 1080-line HD television systems). The imager 101 may include an appropriate interface for generating the image data 111 in the pre-determined format.

The image analysis unit 102 receives the image data 111 and performs one or more image analysis algorithms in order to detect one or more objects within the received image data 111. The analyzed image data 112 (e.g. comprising one or more detected objects) may then be passed to an evaluation unit 103. The evaluation unit 103 may be configured to evaluate the performance of the image analysis unit 102. For this purpose, the evaluation unit 103 may have access to benchmark data, and may be configured to compare the benchmark data with the analyzed image data 112. The benchmark data may e.g. be determined by a person who analyzes the image data 111 provided by the imager 101 and who performs a manual detection of one or more benchmark objects within the image data 111. In any case, the benchmark data may include one or more benchmark objects, and can be compared to the analyzed image data 112 comprising one or more detected objects, in order to determine a performance indicator of the image analysis unit 102 (e.g. in order to determine a detection rate of the image analysis unit 102).

The system 100 of FIG. 1a does not make use of image compression such that the image data 111 generated by the imager 101 is provided—as is—to the image analysis unit 102. Due to the increase of the amount of data transmission within a vehicle and due to the use of a shared network infrastructure (such as Gigabit Ethernet), the image data 111 may be submitted to lossy compression schemes, in order to reduce the bandwidth required for transmitting the image data 111 to the image analysis unit 102. This is illustrated in FIG. 1b which shows an exemplary system 120 for evaluating the performance of a driver assistance system 140 comprising lossy image compression. The image data 111 is encoded (typically directly at the location of the imager 101 prior to transmission over the on-board network of the vehicle) within a compression unit 121 (also referred to as an encoding unit 121). The compression unit 121 may be configured to apply a lossy compression algorithm (e.g. JPEG, MJPEG, MPEG, H.264) to the image data 111, thereby providing compressed image data 131.

The compressed image data 131 is transmitted over the on-board network of the vehicle to a decompression unit 122 (also referred to as a decoding unit 122) which is configured to apply a decompression algorithm (which corresponds to the compression algorithm applied within the compression unit 121) to the compressed image data 131, thereby providing decoded image data 132. The decoded image data 132 typically differs from the (original) image data 111 generated by the imager 101. The deviations of the decoded image data 132 depend on the settings of the compression unit 121, wherein the settings may e.g. relate to one or more of:
the compression algorithm (e.g. MJPEG, JPEG, MPEG, H.264) used within the compression unit 121/decompression unit 122;
the compression ratio (i.e. the ratio of the size (e.g. measured in bits) of the image data 111 and the size (e.g. measured in bits) of the compressed image data 131);
the block-size (in case of a block-based image encoder/decoder) used by the compression algorithm;
a target bit-rate per frame vs. target bit-rate per block (this setting allows to impose a total number of bits for a complete frame of the image data 111, thereby enabling an overall distribution of the total number of bits to a complete frame of the image data 111, vs. to impose a number of bits per block of a frame of the image data 111, thereby ensuring a minimum quality per block of a frame of the image data 111).
a target average bit-rate per second or per pre-determined time interval;
a maximum bit-rate per second or per pre-determined time interval (thereby ensuring that an instantaneous bandwidth does not exceed a pre-determined bandwidth limit);
a quality factor (e.g. a signal-to-noise ratio or a psycho-visually motivated signal-to-noise ratio) to be achieved; the quality factor may be defined as a target (e.g. average) quality factor, as a minimum quality factor or as a maximum quality factor;
a maximum bit-rate per image block (e.g. per macro-block in JPEG);
an amount of cutoff of bits in an encoded frame; such a cutoff may occur before transmission of the image data 111 (notably for bandwidth limitation of the image data 111);
an amount of adjustment and/or a type/algorithm of adjustment of the value for any of the above mentioned settings for the encoding of a current frame, based on the knowledge from the encoding of one or more previous frames;
an amount of adjustment and/or a type/algorithm of adjustment of the value of any of the above mentioned settings before or while encoding the next frame, the next macroblock, and/or the next block;
an amount of adjustment of the value of any of the above mentioned settings, based on the available resources at the encoder, the decoder, and/or on the on-board transmission network;
an amount of adjustment of the value of any of the above mentioned settings, based on one or more active image analysis algorithms used within the image analysis unit 102.

It should be noted that the one or more settings of the compression unit 121 which may be selected and/or modified typically depend on the compression algorithm used within the compression unit 121.

Typically, the compression algorithm applied within the compression unit 121 is directed at achieving a target compression ratio or a target bit-rate subject to psycho-visual quality criteria, thereby reducing artifacts included within the decoded image data 132, which are visible to a human being. The psycho-visual quality criteria may not be optimal when using the decoded image data 132 for image analysis within the image analysis unit 102. As such, a further setting of the compression unit 121 may be
the quality criteria applied by the compression algorithm.

The image analysis unit 102 applies one or more image analysis algorithms to the decoded image data 102 in order to generate the analyzed image data 133. The analyzed image data 133 may comprise one or more detected objects. The evaluation unit 103 determines a performance indicator of the image analysis unit 102 or of the driver assistance system 140 including the imager 101, the compression unit 121, the decompression unit 122 and the image analysis unit 102, based on the analyzed image data 133 and based on benchmark data comprising one or more benchmark objects. The performance indicator may e.g. be directed at a rate of detection of objects captured by the imager 101.

The lossy compression algorithm applied to the image data 111 typically affects the performance of the driver assistance system 140. It is desirable to improve the performance of the driver assistance system 140 by adjusting the various settings of the compression unit 121 depending on the image processing algorithm used within the image analysis unit 102. This may be achieved using a trial-and-error approach by adjusting the settings of the compression unit 121 in conjunction with a particular image processing algorithm during a number of test drives. The use of test drives is, however, time consuming and typically does not lead to optimal results, because the conditions during the test drives are not reproducible. Furthermore, the results obtained during different test drives are usually not comparable, as the conditions during the different test drives (e.g. the conditions of the light and of the objects which are to be detected) vary.

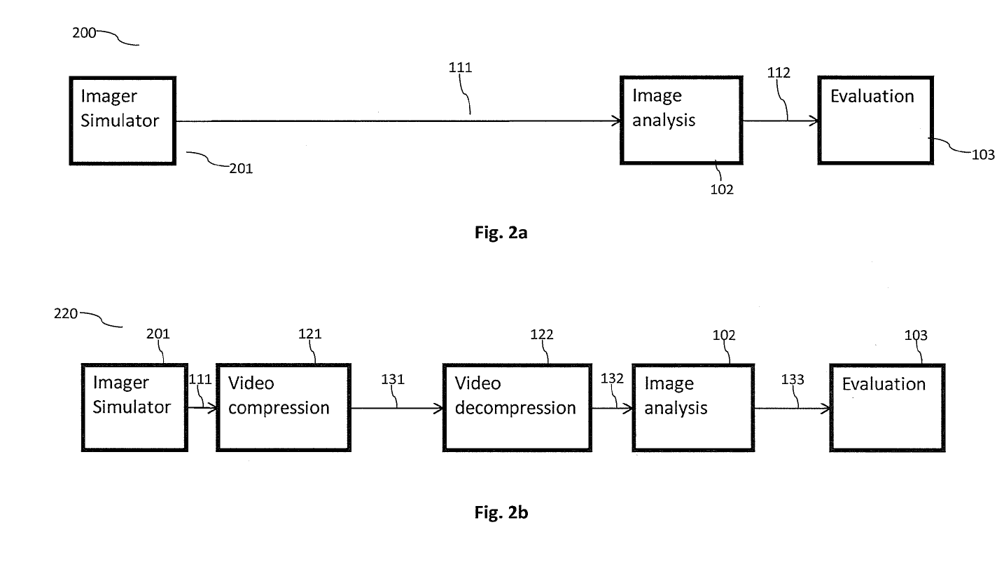

FIGS. 2a and 2b show block diagrams of exemplary systems 200, 220 which may be used to determine and/or tune the driver assistance system of a vehicle in an efficient and reproducible manner. The systems 200, 220 correspond to the systems 100, 120 of FIGS. 1a, 1b, respectively. However, the imagers 101 have been replaced by imager simulators 201, respectively. The imager simulators 201 are configured to provide image data 111 in the same format (e.g. according to the same protocol) as the imagers 101 of FIGS. 1a, 1b. As such, the imager simulators 201 may be coupled to the network (system 200) or to the compression unit 121 (system 220) in the same manner as the actual imagers 101. However, the imager simulators 201 are further configured to render pre-recorded reference data as image data 111. As such, the same image data 111 can be re-produced multiple times (using the pre-recorded reference data), thereby allowing for reproducible test sequences of the driver assistance system of a vehicle. The driver assistance system remains unchanged, apart from the imager 101 which is replaced by the imager simulator 201, thereby allowing for Hardware-in-the-Loop testing which is as close as possible to the actual driver assistance system used within the vehicle.

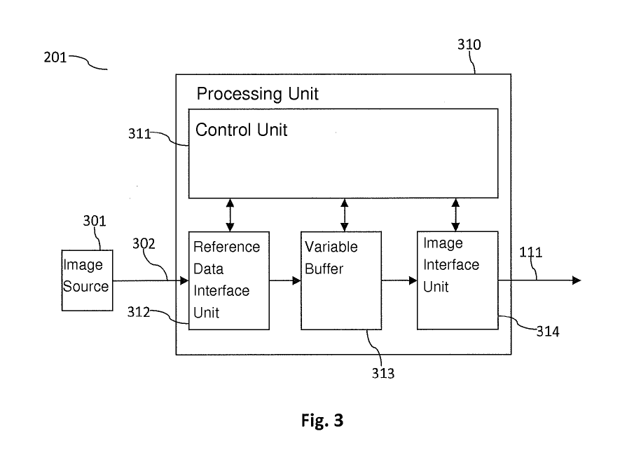

FIG. 3 shows a block diagram of an exemplary imager simulator 201. The imager simulator 201 of FIG. 3 includes an image source 301 (e.g. a personal computer, a logger of video data, or a pattern generator) which is configured to store the pre-recorded reference data 302 and which is configured to provide the pre-recorded reference data 302 to a processing unit 310. The processing unit 310 may be implemented e.g. using an FPGA (field-programmable gate array). The processing unit 310 includes a reference data interface unit 312 which is configured to request and receive the pre-recorded reference data 302 from the image source 301. By way of example, the reference data interface unit 312 includes a Gigabit-Ethernet interface to communicate with the image source 301.

The pre-recorded reference data 302 may be stored in a variable buffer 313. The reference data interface unit 312 may be configured to send control data (e.g. Ethernet SYNC-frames) to the image source 301 in order to control the transmission rate of the pre-recorded reference data 302 from the image source 301. The control data may be sent to the image source 301 in dependence of the fill level of the buffer 313 and/or in dependence of the frame rate of the image data 111 generated by the imager simulator 201, thereby regulating the data flow from the image source 301 to the processing unit 310. The buffer 313 may be configured to compensate for variations in the data flow, thereby ensuring that the image data 111 can be generated at a stable frame rate and/or with a timing which is adjustable to the timing of the compression unit 121 or of the on-board network.

The processing unit 310 includes an imager interface unit 314 configured to generate the image data 111 according to the pre-determined format. As indicated above, the format may e.g. be in accordance to the ITU-R BT.601 or ITU-R BT.709 standards. In particular, the imager interface unit 314 may be configured to take the pre-recorded reference data 302 from the buffer 313 and format the pre-recorded reference data 302 in accordance to the pre-determined format, thereby generating the image data 111. The pre-determined format of the image data 111 may relate to one or more of the following aspects:
the underlying specification (e.g. ITU-R BT.601 or ITU-R BT.709);
the resolution of an image (e.g. 525-lines or 625-lines in case of ITU-R BT.601, or 1080-lines or 1052-lines in case of ITU-R BT.709);
the color space used to represent color information (e.g. the YCbCr color space using a luma component, a blue-difference component and a red-difference component, or the YUV color space using a luma component and two chrominance components);
chroma subsampling (i.e. subsampling of chroma information with respect to luma information, e.g. YCbCr 4:2:2 or YUV 4:2:2);
the number of bits per component (e.g. 8 bits, 10 bits or 12 bits per component);
the frame rate (e.g. 60 Hz, 50 Hz, 30 Hz, 25 Hz, or 24 Hz);
the pixel clock (PCLK), indicating the rate at which a block of data (e.g. 8 bits) is output as image data 111;
a length of the Hsync signal (e.g. pulse) indicating the end of a line; or a length of a Href signal indicating the length of a line;
a polarity of the Vsync signal, indicating the end of a frame;
interlaced or de-interlaced operation of the imager;
timing information to synchronize with the subsequent compression unit 102;
a serial or parallel transmission format.

The imager interface unit 314 may provide a physical interface (e.g. a connector) which is in accordance to the physical interface of the imager 101. By way of example, the imager interface unit 314 may comprise a 25-pin Sub-D connector, in case of parallel transmission format, or a BNC (Bayonet Neill-Concelman) connector for connecting a coaxial cable, in case of serial transmission.

The processing unit 310 may further include a control unit 311 configured to control the operation of the reference data interface unit 312, the buffer 313 and/or the imager interface unit 314. The control unit 311 may be used to configure other interfaces of the processing unit 310, such as a serial interface, an I2C interface and/or an SPI interface (not shown).

The system 220 of FIG. 2b which includes the imager simulator 201 can be used in a method 400 for determining settings of the compression unit 121, which improve the performance of the image analysis performed within the image analysis unit 102 downstream of the compression unit 121. The method 400 makes use of pre-determined reference data 302 stored on the image source 301. In step 401, the pre-determined reference data 302 is rendered as image data 111 using the imager simulator 201. The image data 111 is processed by the compression unit 121 and the de-compression unit 122 using a first set of settings (step 402), thereby generating first decoded image data 132. The image analysis unit 102 analyzes the first decoded image data 132 using one or more image analysis algorithms, thereby yielding first analyzed image data 133 (step 403). Subsequently, the evaluation unit 103 determines a first performance indicator for the image analysis unit 102 based on the first analyzed image data 133 (and possibly based on benchmark data) (step 404).

The above mentioned scheme (i.e. method steps 401 to 404) may be repeated (step 405) for a plurality of different sets of settings of the compression/de-compression units 121, 122 using the same pre-determined reference data 302, thereby determining a corresponding plurality of performance indicators for the image analysis unit 102 (using the one or more image analysis algorithms). The set of settings for a current iteration of the method 400 may be determine based on the sets of settings used for the one or more preceding iterations, and/or based on the performance indicators determined within the one or more preceding iterations. In particular, optimization techniques (such as gradient decent algorithms or heuristic algorithms) may be used to determine the set of settings for the current iteration based on the sets of settings and the performance indicators of the one or more preceding iterations. Alternatively or in addition, the plurality of sets of settings may be pre-determined in accordance to a pre-determined test protocol.

The method 400 may terminate, e.g. after a pre-determined number of iterations, and/or after having determined the plurality of performance indicators for a plurality of pre-determined sets of settings, and/or after having determined a (local) optimum for the performance indicator. The method 400 may then comprise the step 406 of selecting a set of settings from the plurality of sets of settings which corresponds to the maximum performance indicator of the plurality of determined performance indicators. As such, the method 400 allows to determine a set of settings for the compression/decompression units 121, 122 which allows to increase (e.g. maximize) the performance of the image analysis unit 102 (e.g. which allows to maximize the detection rate) when using the one or more image analysis algorithms.

The method 400 may be performed for different image analysis algorithms (e.g. for lane detection and/or for pedestrian detection), thereby determining improved sets of settings for the compression/decompression units 121, 122 for different image analysis algorithms. The respective improved sets of settings may then be used in conjunction with the different image analysis algorithms, thereby improving the performance of the driver assistance system 140 (comprising the actual imager 101), depending on the one or more image analysis algorithms in use. By way of example, the driver assistance system 140 may be configured to perform pedestrian detection up to a pre-determined maximum speed (e.g. of 60 km/h). Furthermore, the driver assistance system 140 may be configured to perform lane detection for speeds higher than the pre-determined maximum speed. As such, the driver assistance system 140 may be configured to use the set of settings which were optimized for pedestrian detection at speeds up to the pre-determined maximum speed, and configured to use the set of settings which were optimized for lane detection at speeds above the pre-determined maximum speed.

The method 400 using the imager simulator 201 allows for a time- and cost-efficient, as well as a reproducible scheme for determining the set of settings for a compression algorithm to be used in conjunction with a particular image analysis algorithm, thereby improving the performance of the particular image analysis algorithm. As a result, the design and the optimization of camera-based driver assistance systems can be accelerated and improved.

It should be noted that various variants of the systems 220 and the method 400 may be implemented:

By way of example, the systems 200, 220 and/or the method 400 may be used to simulate the behavior of the driver assistance system 140 in response to a faulty imager 101. The imager simulator 201 may be configured to generate erroneous image data 111 (e.g. a freeze frame, or frames of a video comprising faulty pixels). The performance of the image analysis unit 102 subject to such erroneous image data 111 may be evaluated, thereby providing insights with regards to the robustness of the driver assistance system 140.

The systems 200, 220 and/or the method 400 may be extended to a plurality of imager simulators 201, thereby simulating the presence of a corresponding plurality of imagers 101 within the driver assistance system 140. By way of example, the plurality of imagers 101 may be used for stereo vision or for parking cameras, and the plurality of imager simulators 201 may be configured to generate appropriate image data 111 (based on appropriate pre-determined reference data 302) in order to simulate such stereo or parking situations. By way of example, the pre-determined reference data 302 for the plurality of imager simulators 201 may have been recorded using the respective imagers 101 of the actual driver assistance system 140. The plurality of imager simulators 201 may be configured to generate the respective image data 111 in a synchronized manner, thereby simulating the real-life situation of the driver assistance system 140. If required, a pre-determined temporal offset between the image data 111 generated by the different imager simulators 201 may be implemented.

As already indicated above, the pre-determined reference data 302 is not limited to image data pre-recorded by an actual imager 101 within the actual driver assistance system 140. By way of example, artificial image data (e.g. generated by a pattern generator) may be used as pre-determined reference data 302, in order to test the driver assistance system 140 under extreme conditions. Alternatively or in addition, the pre-determined reference data 302 may be adapted to test extreme situations with regards to the compression algorithms applied within the compression unit 121. By way of example, the pre-determined reference data 302 may be selected in order to test a “worst case” scenario with regards to compression aspects, thereby allowing to appropriately design the compression unit 121 (e.g. memory and/or processing capacity of the compression unit 121) for such a “worst case” scenario.

It should be noted that the systems 200, 220 and/or the method 400 may be used (alternatively or in addition) to optimize other parameters of the driver assistance system 140. Overall, the imager simulator 201 creates a cost/time-efficient and reproducible test environment for the driver assistance system 140 and may therefore be used to tune the various parameters of the driver assistance system 140 (including those not mentioned in the present document).

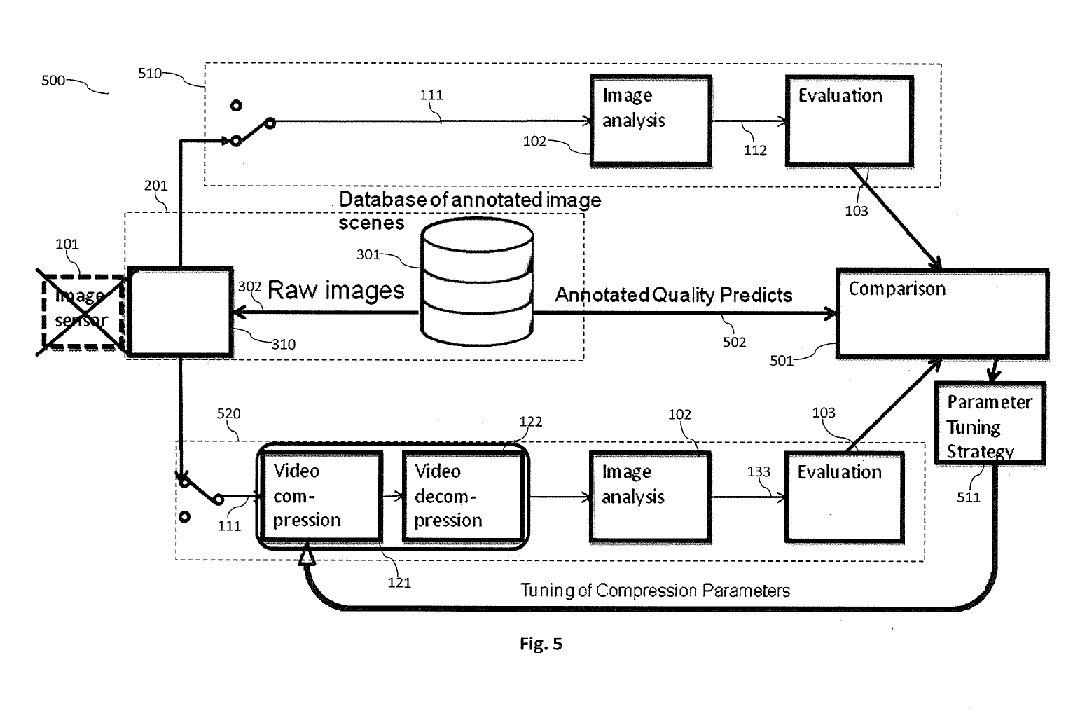

FIG. 5 illustrates a block diagram of another exemplary system 500 for evaluating and/or optimizing the performance of a driver assistance system. The system 500 is particularly advantageous for tuning the one or more settings of the video compression unit 121 (and of the video compression scheme used therein). The system 500 includes a reference system 510 (which—in conjunction with the imager simulator 201—corresponds to the system 200 described in FIG. 2a), which evaluates the performance of the driver assistance system (and in particular, the performance of the image analysis unit 102) without the impact of image compression. The imager simulator 201, including the image source 301 (e.g. a database) and the processing unit 310, provides (raw) image data 111 which is analyzed directly by the image analysis unit 102, thereby providing reference analyzed image data 112. The evaluation unit 103 of the reference system 510 may be configured to determine a performance indicator of the driver assistance system without compression, based on the reference analyzed image data 112. As outlined above, the evaluation unit 103 of the reference system 510 may make use of benchmark data 502 (e.g. benchmark data 502 provided by the imager simulator 201) for this purpose.

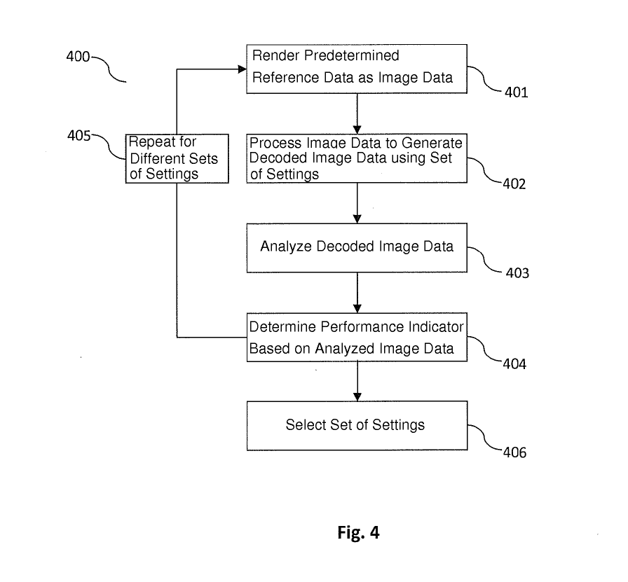

Furthermore, the system 500 includes the evaluation system 520 which—in conjunction with the imager simulator 201—corresponds to the system 220 that has already been described in the context of FIG. 2b. The evaluation unit 103 of the evaluation system 520 determines a performance indicator of the driver assistance system including compression, based on the analyzed image data 112 (and possibly based on the benchmark data 502). The comparison unit 501 of system 500 may be configured to compare the performance indicators provided by the reference system 510 and by the evaluation system 520. By using the information provided by the reference system 510, the comparison unit 501 is enabled to clearly identify the performance deteriorations of the image analysis unit 102 which are due to the image compression applied within the driver assistance system. In particular, the comparison unit 501 may exclude performance issues which are inherent to the image analysis algorithm used within the image analysis unit 102 (and which are not necessarily due to compression). The system 500 may further include a parameter tuning unit 511 which is configured to tune the one or more settings of the compression scheme used within the compression unit 121 (using the feedback provided by the comparison unit 501), thereby improving the overall performance of the driver assistance system comprising image compression (e.g. using the method of FIG. 4).

In the present document methods and systems for improving the performance of a camera-based driver assistance system have been described. In particular, an imager simulator has been described which may be used in lieu of an actual imager of the camera-based driver assistance system, thereby allowing to test the camera-based driver assistance system in an efficient and reproducible manner. A setup comprising the imager simulator may be used to adjust various parameters of the camera-based driver assistance system (in particular, to adjust the settings of a compression unit included within the camera-based driver assistance system), thereby improving the overall performance of the camera-based driver assistance system.

The methods and systems described in the present document may be implemented as software, firmware and/or hardware. Certain components may e.g. be implemented as software running on a digital signal processor or microprocessor. Other components may e.g. be implemented as hardware and or as application specific integrated circuits. The signals encountered in the described methods and systems may be stored on media such as random access memory or optical storage media. They may be transferred via networks, such as radio networks, satellite networks, wireless networks or wireline networks, e.g. an Ethernet network. Typical devices making use of the methods and systems described in the present document are driver assistance systems in a vehicle (e.g. in a car or a truck).

The software may be referred to as a computer program and the invention may also be implemented in a computer program for running on a programmable apparatus, at least including code portions for performing steps of a method according to the invention when run on a programmable apparatus, such as a computer system or enabling a programmable apparatus to perform functions of a device or system according to the invention.

The computer program may be stored, e.g. internally in the programmable apparatus, on a computer readable storage medium or transmitted to the programmable apparatus via a readable transmission medium. All or some of the computer program may be provided on tangible or non-tangible computer readable media permanently, removably or remotely coupled to an information processing system. The computer readable media may be transitory or non transitory and include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An imager simulator configured to be used in lieu of an imager within a vehicle, the imager simulator comprising:
an image source configured to store pre-determined reference data; and
an imager interface unit configured to generate image data based on the pre-determined reference data, wherein
the image data conforms to a pre-determined format, and
the pre-determined format corresponds to a format of image data generated by the imager.

2. The imager simulator according to claim 1, wherein the pre-determined format comprises at least one of:
a pre-determined standard;
a resolution of a frame of the image data;
a frame-rate of succeeding frames of the image data;
a color space used to represent color information included within the image data;
a chroma subsampling scheme;
a number of bits used to encode a pixel of the image data;
a rate at which the bits which encode the pixel of the image data are transmitted;
a use of synchronization signals;
an interlaced or de-interlaced operation of the imager;
timing information for synchronization of the imager simulator with one or more components downstream of the imager; or
a serial or parallel transmission of the image data.

3. The imager simulator according to claim 1, wherein the imager simulator comprises a physical connector which conforms to a physical connector of the imager.

4. An evaluation system for determining a performance indicator of an imager-based driver assistance system, the evaluation system comprising:
an imager simulator configured to be used, in lieu of an imager of the driver assistance system, wherein the imager simulator comprises:
an image source configured to store pre-determined reference data; and
an imager interface unit configured to generate image data based on the pre-determined reference data, wherein
the image data conforms to a pre-determined format, and
the pre-determined format corresponds to a format of image data generated by the imager;
an image analysis unit configured to analyze data derived from the image data, thereby generating analyzed image data; and
an evaluation unit configured to determine the performance indicator based on the analyzed image data.

5. The evaluation system according to claim 4, wherein the evaluation unit is configured to determine the performance indicator also based on benchmark data derived from the pre-determined reference data.

6. The evaluation system according to claim 5, wherein
the benchmark data is indicative of one or more benchmark objects,
the analyzed image data is indicative of zero or more detected objects, and
the performance indicator comprises a detection rate of the one or more benchmark objects within the analyzed image data.

7. The evaluation system according to claim 6, further comprising:
a compression unit configured to encode the image data using a lossy compressing scheme, thereby yielding compressed image data; and
a decompression unit configured to decode the compressed image data, thereby yielding decoded image data; wherein the image analysis unit is configured to analyze the decoded image data to provide the analyzed image data.

8. The evaluation system according to claim 4, further comprising:
a compression unit configured to encode the image data using a lossy compressing scheme, thereby yielding compressed image data; and
a decompression unit configured to decode the compressed image data, thereby yielding decoded image data; wherein the image analysis unit is configured to analyze the decoded image data to provide the analyzed image data.

9. The evaluation system according to claim 7, wherein the compression unit comprises at least one of the following adjustable settings:
the compression scheme used within the compression unit;
an overall target bit-rate or an overall compression ratio implemented by the compression scheme;
a maximum bit-rate per frame of the image data or a maximum bit-rate per subregion of a frame of the image data;
a target average bit-rate per pre-determined time interval;
a maximum bit-rate per pre-determined time interval;
a minimum value for a quality of the compressed image data with respect to the image data; or
a quality criteria applied by the compression scheme when encoding the image data.

10. The evaluation system according to claim 7, further comprising:
a reference image analysis unit configured to analyze the image data, thereby generating reference analyzed image data; and
a comparison unit configured to determine a performance deterioration of the imager-based driver assistance system due to the lossy compressing scheme applied to the image data, based on the reference analyzed image data and based on the analyzed image data.

11. A method for determining a performance indicator of an imager-based driver assistance system, the method comprising the acts of:
generating image data based on pre-determined reference data using an imager simulator in lieu of an imager of the driver assistance system;
analyzing data derived from the image data using a first image analysis algorithm, thereby generating analyzed image data; and
determining the performance indicator based on the analyzed image data.

12. The method according to claim 11, wherein the pre-determined reference data comprises at least one of:
image data recorded using the imager of the driver assistance system;
image data generated by a pattern generator; or
image data representing a freeze image.

13. The method according to claim 12, further comprising the acts of:
encoding the image data using a lossy compressing scheme and a set of settings for the compression scheme, thereby yielding compressed image data; and
decoding the compressed image data, thereby yielding decoded image data; wherein the analyzed image data is determined based on the decoded image data.

14. The method according to claim 11, further comprising the acts of:
encoding the image data using a lossy compressing scheme and a set of settings for the compression scheme, thereby yielding compressed image data; and
decoding the compressed image data, thereby yielding decoded image data; wherein the analyzed image data is determined based on the decoded image data.

15. The method according to claim 13, further comprising the acts of:
repeating the generating, the encoding, the decoding, the analyzing and the determining acts using the same pre-determined reference data and using a plurality of different sets of settings of the compression scheme, thereby yielding a corresponding plurality of performance indicators; and
selecting a set of settings from the plurality of different set of settings based on the plurality of performance indicators.

16. The method according to claim 14, further comprising the act of determining the plurality of performance indicators using a second image analysis algorithm, different from the first image analysis algorithm.

17. An imager-based driver assistance system for a vehicle, comprising:
an imager configured to generate image data;
a compression unit configured to encode the image data using a lossy compressing scheme, thereby yielding compressed image data; wherein the compression scheme is adjustable using one or more settings;
a decompression unit configured to decode the compressed image data, thereby yielding decoded image data;
an image analysis unit configured to analyze the decoded image data using at least one of a plurality of image analysis algorithms, thereby yielding analyzed image data; wherein the analyzed image data is usable for assisting a driver of the vehicle; and
a memory unit configured to store one or more settings of the compression scheme for each of the plurality of image analysis algorithms, respectively; wherein the driver assistance system is configured to set the one or more settings stored in the memory unit, in dependence of the at least one image analysis algorithm used by the image analysis unit.
